(19) United States
(12) Patent Application Publication
(10) Pub. No.: US 2026/0227526 A1
(43) Pub. Date: Aug. 6, 2026

(54) METHOD FOR REJECTING ANOMALOUS PHASE MEASUREMENTS AND PROLONGING A NAVIGATION SOLUTION

(71) Applicant: TOPCON POSITIONING SYSTEMS, INC., Livermore, CA (US)

(72) Inventors: Mark Isaakovich ZHODZISHSKY, Moscow (RU); Alexey Vasilievich BASHAEV, Moscow (RU); Fedor Borisovich SERKIN, Moscow (RU); Sergey Mikhailovich PICHUGIN, Moscow (RU)

(73) Assignee: TOPCON POSITIONING SYSTEMS, INC., Livermore, CA (US)

(21) Appl. No.: 19/149,835

(22) PCT Filed: Feb. 27, 2023
(86) PCT No.: PCT/RU2023/000050

§ 371 Date: Jul. 21, 2025

(51) Int. Cl. G01S 19/39; G01S 19/29; G01S 19/30; G01S 19/32

(52) U.S. Cl. CPC G01S 19/396; G01S 19/29; G01S 19/30; G01S 19/32

(57) ABSTRACT

This monograph provides a comprehensive analysis of equipment used for high-precision positioning based on signals from global navigation satellite systems (GNSS), such as GPS, GLONASS, and others. The focus is on receivers and user-end equipment—referred to as “receivers-consumers of navigation information” that utilize GNSS signals for real-time, high-accuracy location and timing applications.

The book explores the theoretical foundations, signal processing techniques, error sources, and methods of increasing positioning accuracy, including differential GNSS (DGNSS), carrier-phase tracking, and real-time kinematic (RTK) methods. It addresses both civilian and military applications and examines the requirements for hardware and software implementations in navigation receivers.

Special attention is given to the system design of GNSS receivers, including architecture, antenna technologies, and integration with other sensors (e.g., inertial navigation systems). The authors also discuss certification standards, testing methods, and trends in the development of high-precision GNSS technologies.

This work serves as both a technical reference and a practical guide for engineers, researchers, and developers involved in the design and deployment of GNSS-based positioning systems.

### FIELD OF THE INVENTION

The present invention relates generally to navigation receiver operation and, more particularly, to detecting anomalous measurements of a movable navigation receiver (also referred to as a rover) and prolonging a navigation solution over time intervals to compensate for the anomalous measurements.

### BACKGROUND

Navigation receivers receive radio signals from a plurality of navigation satellites (“NS”). By processing these signals, a movable receiver or rover determines the location and speed of movement of its antenna, i.e. it provides a position, velocity, and timing (“PVT”) solution.

Under difficult operating conditions of the rover, for example, when part of the radio signals are shaded and/or there is a strong multipath signal, anomalous signals containing unacceptably large errors appear and can disrupt operation of the rover. If these anomalous measurements (“anomalies”) are not eliminated, they will lead to unacceptably large errors in the PVT solution. What is needed is a robust PVT solution that provides accurate information despite anomalies.

### SUMMARY

A method for rejecting anomalous measurements and prolonging a navigation solution of a GNSS receiver according to one embodiment includes the step of computing a calculated full phase (“FP”) for tracked navigation satellites (“NS”) based on the GNSS receiver's coordinate predictions. Individual loop (“IL”) discriminator signals for the tracked NS are then computed. Discriminator signals of M number of NS are rejected and corresponding flags are generated. Common loop (“CL”) discriminator signals are computed based on K number of non-rejected IL discriminator signals. Current estimates of coordinates and the GNSS receiver's time scale (“RTS”) are then calculated. FP for the tracked NS are calculated based on current estimates of the GNSS receiver coordinates. A correction IL discriminator signal for the M number of NS is calculated. An estimate of integer ambiguity (“IA”) is calculated. The correction IL discriminator signal based on the IA estimate is recalculated. FP residual estimates are calculated. SF signals based on current estimates and prediction of receiver coordinates are calculated and then receiver coordinate predictions are calculated.

A method for rejecting anomalous measurements and prolongation of FP according to one embodiment includes the step of calculating IL discriminator signals for NS being tracked. IL discriminator signals of M number of NS are rejected and corresponding flags are formed. CL discriminators from K non-rejected signals of the IL discriminators are then calculated. Correction discriminator signals based on CL discriminator signals are calculated. FP estimates, Doppler frequency, and rate of change of Doppler frequency for NS being tracked are calculated and FP predictions, Doppler frequency, and rate of change of Doppler frequency for the NS being tracked are calculated.

A method for generating IL discriminator signals in multi-frequency receivers for NS emitting signals in K frequency band according to one embodiment includes the step of determining an IL discriminator signal

$${z}_{i}^{d , ind , f , j}$$

for each frequency band f. Obtained values

$${z}_{i}^{d , ind , f , j}$$

are verified based on criteria comprising SNR for j-th NS in frequency band f being greater than threshold hₛₙᵣ, and the absolute value of

$${z}_{i}^{d , ind , f , j}$$

being smaller than threshold h_{φ}. If for signal

$${z}_{i}^{d , ind , f , j}$$

one of the criteria is not satisfied, the corresponding signal is rejected and a corresponding flag is formed. Complex IL discriminator signal

$${z}_{i}^{d , ind , j}$$

is formed from L non-rejected signals of the j-th NS using equation:

$${Z}_{i}^{d , ind , j} = \frac{{\sum }_{f = 1}^{L} {w}_{f} {z}_{i}^{d , ind , f , j}}{{\sum }_{f = 1}^{L} {w}_{f}}$$

where estimates of energy potential for the f-th signal or another value characterizing “worth” of the f-th signal can be used as a weighting. In one embodiment, replacing terms in the formula above produces the equation

$${z}_{i}^{d , ind , j} = \frac{1}{L} {\sum }_{f = 1}^{L} {z}_{i}^{d , ind , f , j} .$$

Systems configured to perform the above identified methods are also described herein.

### BRIEF DESCRIPTION OF THE DRAWINGS

FIG. 1 shows a Global Navigation Satellite System (“GNSS”) receiver according to one embodiment;

FIG. 2 shows a block diagram of a buffer corrector block according to one embodiment;

FIG. 3 shows a block diagram of a buffer corrector block according to one embodiment;

FIG. 4 shows a flowchart of a method for rejecting anomalous measurements and prolonging a navigation solution of a GNSS receiver according to one embodiment;

FIG. 5 shows a flowchart of a method for rejecting anomalous measurements and prolongation of FP according to one embodiment;

FIG. 6 shows a flowchart of a method for generating of IL discriminator signals in multi-frequency receivers for NS emitting signals in K frequency band according to one embodiment; and

FIG. 7 shows a high-level block diagram of a computer according to an embodiment.

### DETAILED DESCRIPTION

It should be noted that, in one embodiment, a receiver's coordinates xᵢ, yᵢ, zᵢ and NS coordinates (j-th satellite)

$${x}_{i}^{j} , {y}_{i}^{j} , {z}_{i}^{j} ;$$

radial range

$${D}_{i}^{j} ;$$

receiver time scale qᵢ and NS time scale

$${q}_{SV . i}^{j} ;$$

wavelength λ; all phases; measured

$${φ}_{i}^{j} ;$$

residuals

$${δφ}_{i}^{j} ;$$

calculated

$${φ}_{c alc , i}^{j} ;$$

corrected

$${δφ}_{i}^{corr} ;$$

discriminator output signals (for individual loops

$${Z}_{i}^{d , ind , j}$$

and common loops

$${Z}_{i}^{d , c} ,$$

correction

$${Z}_{i}^{corr , j} )$$

are measure in meters [m].

A method for rejecting anomalies that can cause errors in position, velocity, and timing (“PVT”) solutions is described herein. In addition, a method for the prolongation (e.g., extrapolation or extension) of PVT solutions is also described. For obtaining a PVT solution in GNSS receivers, the least squares method (“LSM”) is usually used with satellite measurements (after rejecting anomalies). More precisely, the LSM is usually used with the deviations of these measurements rather than their predicted values. However, after a small number of measurements, the LSM stops working (i.e., no longer produces useful results), which leads to the need for prolongation. This problem does not arise if the LSM is replaced by Kalman filtering (“KF”), but such a replacement leads to a significant complication of the calculations. A number of methods have been proposed to carry out the prolongation without complicating the calculations caused by the transition from LSM to KF, but each method has significant drawbacks. A different method for prolongation is described herein that does not have the drawbacks of the previously proposed methods.

Various algorithmic solutions are used to accomplish the method for rejecting anomalies and the method for prolongation of PVT solutions. These solutions have significant common features. In one embodiment, the solutions are performed by a buffer corrector (“BC”) of a GNSS receiver which operates as shown in the figures and described below. The present disclosure describes the following two BC variants.

In the first variant, fast-changing full phase (“FP”) parts are eliminated by subtracting calculated values related to navigation satellite movements, receiver movements, and fluctuations of receiver's time scale from full phases. In this variant, slowly-changing FPs (e.g., slow full phases) that are independent for different navigation satellites are isolated. These slow parts are then tracked by individual loops (“IL”). IL output signals are either a prediction or an estimate of these slow FPs.

In the second variant, fast-changing FP parts are directly tracked. Fast FP changes are caused by navigation satellites, receiver movements, and fluctuations of a receiver's time scale.

The following notations, terms, and abbreviations are used herein.

Co-Op—a conditional designation of heuristic algorithms with both common loops tracking relatively fast wideband effects common to all GNSS satellites (e.g., antenna phase center offsets and fluctuations of a receiver quartz), and individual loops tracking relatively slow narrow-band effects that are specific for each satellite (e.g., frequency fluctuations of an onboard reference of the given satellite, atmosphere delays in signal propagation).

Single-parameter Co-Op—has only one common loop, specifically a quartz loop, designed for tracking receiver quartz standard frequency (phase), i.e., for tracking fluctuations of receiver time scale.

Multi-parameter Co-Op—has at least three geometric common loops in addition to common quartz loop to track phase center movements along each of three axes (for instance, along axes X, Y, Z in a geometric coordinate system or East, North, Up (“E, N, U”) of a local coordinate system).

Primary Co-Ops—are intended for primary processing of radio signals, namely, for their synchronization of the carrier phase. In other embodiments, these tasks are performed, respectively, by a carrier synchronization systems phase-locked loop or frequency-locked loop (“PLL”, “FLL”). The regulation frequency of the tracking systems in the primary processing are generally on the order of 200-1000 Hz.

Secondary Co-Ops—are intended for processing FP measurements. A regulation/control frequency in ILs and common loops (“CL”) is at least 5 Hz in one embodiment.

Since only secondary Co-Ops are used in the present disclosure, the adjective “secondary” is omitted.

In one embodiment, common and individual loops include a discriminator and a loop filter.

In multi-parameter Co-Ops according to one embodiment, there is one complex CL discriminator in the form of an LSM block for the signals of the IL discriminators. The complex signal at the output of this complex CL discriminator comprises 4 components, for example, according to the geometric coordinates X, Y, and Z, and according to receiver time scale-q. As such, in some instances, each output of each of four common loop discriminators includes its own scalar signal based on the listed coordinates.

In the case of a single-parameter Co-Op, only one CL discriminator signal is formed using the weighted summation of IL discriminator signals according to receiver time scale q.

In one embodiment, loop filters are used to provide the order of astatism of the CLs and the ILs and the equivalent noise bands of the corresponding loops.

In various embodiments, a Co-Op works with FP or with FP functional transformations. These FPs contain a fast part caused by the motion of the NS, the motion of the receiver, the rotation of the Earth, and fluctuations of the time scale. In addition, each FP contains a slow part caused by fluctuations in the NS time scale, atmospheric shifts, and/or phase shift prediction errors due to the motion of the NS. These slow effects are tracked by the ILs.

The fast part of the FP (having a narrow-band component) caused by the motion of the NS is individual for each NS and it can be calculated using ephemeris data and compensated for based on the result of the calculation using ephemeris.

The fast parts of the FP (having a broadband component) due to the movement of the receiver and the fluctuations of the time scale are caused by effects common to all satellites. In one embodiment CLs are used to track them.

Pseudo-measurements (“PM”)—in the present disclosure there are coordinate PMs (“CPM”). Predictions of antenna phase center (i.e., the three geometric coordinates) and a receiver's time scale can be used as a CPM. Positioning algorithms jointly process both real measurements (“RM”) and PM. In one embodiment, RMs are considered having a greater weight and PMs are considered having a smaller weight.

External applications—applications that are external relative to the BC algorithms for example, smoothing filters (“SF”), navigation algorithms (RTK, DGPS etc.) etc.

LSM—a least-squares method generating four CL discriminator signals that are components of one complex CL discriminator signal

$${Z}_{i}^{d , c} .$$

Positioning algorithms, such as RTK, PPP, Stand Alone etc. can be used with the BC to determine various information.

BC-min—an algorithm that is run once based on data from one of the positioning algorithms at the start of or after the recovery of the PVT solution, and then operates independently. The main purpose is the rejection of anomalies, and an additional purpose is the prolongation of the initial navigation.

BC with one-side weak integration—the BC with one-side weak integration differs from BC-min by periodic (approximately every 2 to 10 sec) correction by the positioning algorithm, which leads to a significant increase in the prolongation accuracy due to a decrease in the prolongation time.

With weak integration, the BC is periodically (for example, every 2 seconds or after the recovery of the navigation solution) corrected according to navigation algorithm data, for which the current estimates of the receiver coordinates are used as shown in the equation Xᵢ=[xᵢ, yᵢ, zᵢ]^{T}.

BC with two-side weak integration—BC with two-side weak integration differs from the BC with one-side weak integration by outputting a health flag of raw data from the BC to a positioning algorithm. This flag is used in positioning as an additional catcher.

With two-side weak integration, the BC generates signals for rejecting anomalous FP measurements, primarily for rejecting the tracking of the reflected signal in situations when the amplitude of the reflected signal is greater than the amplitude of the direct signal.

Epoch—a time interval with which measurements are received in the BC.

Step—an epoch number.

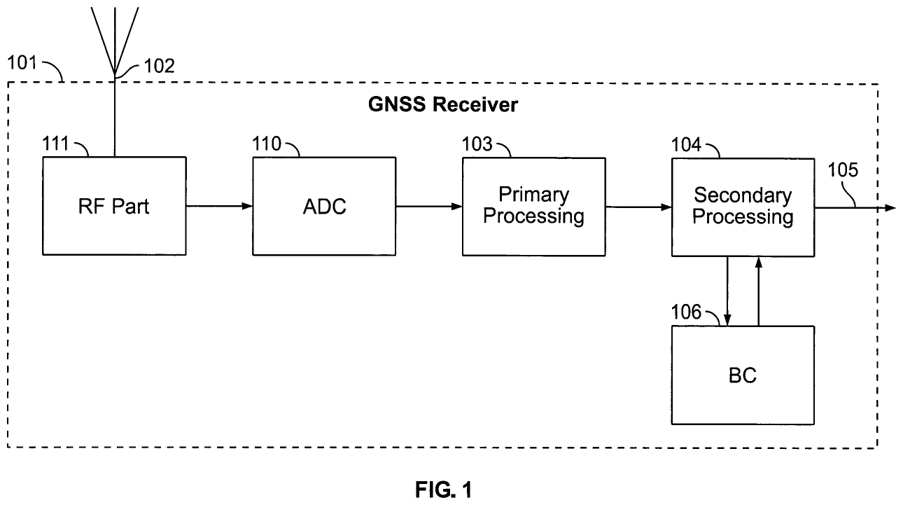

FIG. 1 shows GNSS receiver 101 according to one embodiment. GNSS receiver 101 can be located on a rover and movable (referred to as a moveable receiver). A radio signal emitted by a GNSS satellite is received by antenna 102 and is then processed by RF part 111 of GNSS receiver 101. The output of RF part 111 is input to ADC 110 where it is converted to a digital signal. Digital readings of correlation components are output from the ADC and input to primary processing block 103, which performs the primary processing of the received signal. Primary processing block 103 measures the full phase (“FP”) of the carrier of the received NS signal and the code delay of the received NS signal, measures the signal-to-noise ratio (“SNR”), and also processes information transmitted from the satellite (eg, ephemeris information). These measurements and the received information are input to secondary processing block 104, which uses the measurements and received information to solve a navigation task. Secondary processing block 104 estimates the position and/or speed of the movable receiver (i.e., the antenna of the movable receiver) and outputs them via line 105.

In one embodiment, the data output by secondary processing block 104 is input to buffer corrector block 106 (also referred to as BC block 106, or BC 106), which detects anomalous measurements and outputs appropriate flags back to secondary processing block 104. Two different embodiments of BC block 106 implementation are described herein. Both embodiments use secondary multi-parameter Co-Op.

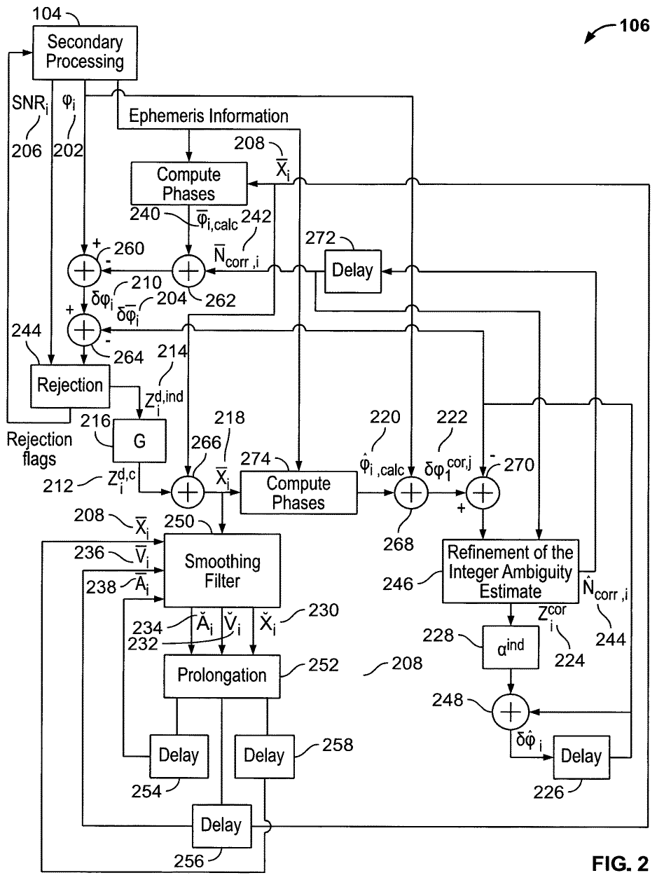

FIG. 2 shows a block diagram of a first embodiment in which BC block 106 is implemented with a secondary Co-Op and prolongation of a navigation solution. In this embodiment, BC block 106 uses secondary Co-Op two-side weak integration and FP integer correction. In accordance with this embodiment, BC block 106 receives information from secondary processing block 104 and operates as described below.

At an i-th step of an algorithm for M observed NSs (i.e., the number of navigation satellites from which the mobile receiver is receiving signals) the following values are determined: values for measured FP φᵢ 202 defined using the equation

$${φ}_{i} = {[ \begin{matrix}{φ}_{i}^{1} & … & {φ}_{i}^{j} & … & {φ}_{i}^{M}\end{matrix} ]}^{T}$$

are determined and output from secondary processing block 104; FP residuals predictions δφ̅ᵢ 204 defined using the equation

$$δ {\overline{φ}}_{i} = {[ \begin{matrix}δ {\overline{φ}}_{i}^{1} & … & δ {\overline{φ}}_{i}^{j} & … & δ {\overline{φ}}_{i}^{M}\end{matrix} ]}^{T}$$

are determined; and signal-to-noise ratio (in dB-Hz) SNRᵢ 206 defined using the equation

$$S N {R}_{i} = [ \begin{matrix}SN {R}_{i}^{1} & … & {SNR}_{i}^{j} & … & {SNR}_{i}^{M}\end{matrix} ]$$

is output from secondary processing block 104.

Using ephemeris information, the coordinates of the j-th NS (coordinates

$${x}_{sv , i}^{j} , {y}_{sv , i}^{i} , {z}_{sv , i}^{j} )$$

and NS time scale drift

$${q}_{sv , i}^{j}$$

for a current epoch i are calculated at the moment of signal emission.

Using the calculated coordinates of the NS and a priori estimates of the coordinates of the receiver, which are extrapolated estimates of the coordinates X̅ᵢ 208 calculated using the equation X̅ᵢ=[x̅ᵢ, y̅ᵢ, z̅ᵢ]^{T}, a priori values of pseudoranges are calculated using the equation:

$${\overline{D}}_{i}^{j} = \sqrt{{( {\overline{x}}_{i} - {x}_{i}^{j} )}^{2} + {( {\overline{y}}_{i} - {y}_{i}^{j} )}^{2} + {( {\overline{z}}_{i} - {z}_{i}^{j} )}^{2}} . \qquad ( 1 )$$

Calculated FP, including corrections for Earth rotation

$${D}_{rot , i}^{j} ,$$

troposphere delays

$${D}_{trop , i}^{j}$$

and ionosphere delays

$${D}_{ion , i}^{j} ,$$

is computed using the following equation:

$${\overline{φ}}_{calc , i}^{j} = {\overline{D}}_{i}^{j} + {D}_{rot , i}^{j} + {D}_{trop , i}^{j} - {D}_{ion , i}^{j} + {q}_{i} - {q}_{sv , i}^{j} . \qquad ( 2 )$$

A column vector of FP residuals is formed, which takes into account the prediction of an integer correction using the equation:

$${δφ}_{i} = {φ}_{i} - {\overline{φ}}_{calc , i} - λ {\overline{N}}_{corr , i} , \qquad ( 3 )$$

where the terms δφᵢ 210, φᵢ 202, φ̅_{calc,i} 240, λN̅_{corr,i} 242 are shown in FIG. 2 and

$${\overline{φ}}_{calc . i} = {[ {\overline{φ}}_{calc , i}^{1} … {\overline{φ}}_{calc , i}^{M} ]}^{T} , {\overline{N}}_{corr , í} = {[ {\overline{N}}_{corr , i}^{1} … {\overline{N}}_{corr , i}^{M} ]}^{T} ,$$

λ is the wavelength of a NS signal.

For all NS, the signals of IL discriminators are calculated using the equation:

$${z}_{i}^{d , ind , j} = {δφ}_{i}^{j} - δ {\overline{φ}}_{i}^{j} . \qquad ( 4 )$$

The obtained values

$${z}_{i}^{d , ind , j}$$

in rejection block 244 of FIG. 2 are verified for validity according to two criteria:

$${SNR}_{i}^{j}$$

for j-th NS is greater than the threshold hₛₙᵣ=10 dB·Hz; and value

$${z}_{i}^{d , ind , j}$$

by modulo is smaller than the threshold h_{φ}=0.08 m.

If for the signal

$${z}_{i}^{d , ind , j}$$

one of the criteria is not met, then the corresponding signal is rejected. The corresponding rejection flag is generated in rejection block 244 and transmitted to secondary processing block 104.

The set of N non-rejected signals of discriminators (shown in equation 4) form the vector of signals of IL discriminators

$${Z}_{i}^{d , ind}$$

214 defined using the equation

$${Z}_{i}^{d , ind} = {[ {z}_{i}^{d , ind , 1} , {z}_{i}^{d , ind , 2} , … , {z}_{i}^{d , ind , N} ]}^{T}$$

### for the LSM.

Using the LSM algorithm, the signals of the CL discriminators

$${Z}_{i}^{d , c}$$

212 are defined using the equation:

$${Z}_{i}^{d , c} = {G}_{i} {Z}_{i}^{d , ind} ≡ {[ {z}_{i}^{d , x} ; {z}_{i}^{d , y} ; {z}_{i}^{d , z} ; {z}_{i}^{d , q} ]}^{T} , \qquad ( 5 )$$

where

$${Z}_{1}^{d , c}$$

### 212, Gᵢ 216, and

$${Z}_{i}^{d , ind}$$

214 are shown in FIG. 2 and

$${G}_{i} = {[ {H}_{i}^{T} {W}_{i} {H}_{i} ]}^{- 1} {H}_{i}^{T} {W}_{i} ,$$

where Hᵢ is the direction cosine matrix added with a unit column and rows having unit elements arranged diagonally, Wᵢ is the diagonal weight matrix whose elements are proportional to

$${SNR}_{i}^{j} .$$

Diagonal elements are calculated using the following equation:

$${w}_{i}^{j} = 1 {0}^{0.1 {SNR}_{i}^{j}} . \qquad ( 6 )$$

A variant of the LSM using coordinate PM (“CPM”) is used in one embodiment in which the navigation solution does not degenerate even with a complete loss of tracking of all NS. In addition, implicitly, due to the CPM, the estimates

$${Z}_{i}^{d , c}$$

212 are smoothed. In one embodiment, the degree of smoothing is determined by the weights of the CPM. In one embodiment, by default, CPM weight w_{KPI}=500 (which corresponds to the standard deviation of the a priori coordinate prediction error of 0.044 m). When used as a point of linearization PM, extrapolated estimates X̅ᵢ=[x̅ᵢ, y̅ᵢ, z̅ᵢ, q̅ᵢ]^{T} are always equal to 0, i.e.,

$${z}_{i}^{d , ind , j ,} = 0 for i = N + 1 , … , N + 4.$$

In one embodiment, matrix Hᵢ is supplemented with rows with single elements arranged diagonally as shown in equation 7 below.

$${H}_{í}^{N + 1} = [ 1 , 0 , 0 , 0 ] , \qquad ( 7 )$$

$${H}_{i}^{N + 2} = [ 0 , 1 , 0 , 0 ] ,$$

$${H}_{i}^{N + 3} = [ 0 , 0 , 1 , 0 ] ,$$

$${H}_{i}^{N + 4} = [ 0 , 0 , 0 , 1 ] .$$

Estimates of receiver coordinates and the receiver's time scale drift \hat{X}ᵢ 218 is defined using the equation \hat{X}ᵢ=[\hat{x}ᵢ, ŷᵢ, \hat{z}ᵢ, \hat{q}ᵢ] and at any particular time are calculated based on CL discriminator signals using the equation:

$${\hat{X}}_{i} = {\overline{X}}_{i} + {Z}_{i}^{d , c} , \qquad ( 8 )$$

where \hat{X}ᵢ 218, X̅ᵢ 208, and

$${Z}_{i}^{d , c}$$

212 are shown in FIG. 2. Then, calculated FP estimates \hat{φ}_{calc,i} 220 of equation

$${\hat{φ}}_{calc , i} = {[ {\hat{φ}}_{calc , i}^{1} … {φ}_{calc , i}^{M} ]}^{T}$$

are calculated according to current receiver coordinates and time scale drift \hat{X}ᵢ 218, taking into account corrections for Earth rotation

$${D}_{rot , i}^{j} ,$$

troposphere delays

$${D}_{trop , i}^{j} ,$$

and ionosphere delays

$${D}_{ion , i}^{j} ,$$

as well as NS time scale drift

$${q}_{sv , i}^{j}$$

using the equation:

$${\hat{φ}}_{calc , i}^{j} = {\hat{D}}_{i}^{j} + {D}_{rot , i}^{j} + {D}_{trop , i}^{j} - {D}_{ion , i}^{j} - {\hat{q}}_{i} - {q}_{sv , i}^{j} . \qquad ( 9 )$$

A column vector of differences between the observed and calculated estimates of the FP is formed using the equation:

$${δφ}_{i}^{cor} = {φ}_{i} - {\hat{φ}}_{calc , i} . \qquad ( 10 )$$

Corrective signals of IL discriminators

$${Z}_{i}^{cor}$$

224 are calculated in refinement of the integer ambiguity estimate block 246 using the equation:

$${Z}_{i}^{cor} = {[ {z}_{i}^{cor , 1} … {z}_{i}^{cor , M} ]}^{T} = {δφ}_{i}^{cor} - δ {\overline{φ}}_{i} . \qquad ( 11 )$$

The correction signals of the IL discriminators

$${z}_{i}^{cor , j}$$

are compared with the threshold h_{φ}. If a signal goes beyond the boundaries defined by its threshold, then an integer correction is performed, i.e. estimates of integer ambiguity (“IA”) are refined using the equations:

$${\hat{N}}_{corr , i}^{j} = {\overline{N}}_{corr , i}^{j} + δ {N}_{i}^{j} , δ {N}_{i}^{j} = floor \{ \frac{{z}_{i}^{cor , j}}{λ} \} , \qquad ( 12 )$$

and the correction signals of the IL discriminators are recalculated using the equation:

$${Z}_{i}^{cor} ← {Z}_{i}^{cor} - λδ {N}_{i} . \qquad ( 13 )$$

In equation 12, floor{ } is the operation of rounding up to the previous integer, ← in the equation 13 is the operation of replacing the original values with new ones, as shown by the equation

$$δ {N}_{i} = {[ δ {N}_{i}^{1} … δ {N}_{i}^{M} ]}^{T} .$$

For signals containing bit information (i.e. data-signals), the IA compensation is a multiple of 0.5 cycles (0.5λ). For signals without bit information (i.e., pilot-signals), the IA is a multiple of 1 cycle (λ).

Then predictions of FP residuals are calculated

$$δ {\overline{φ}}_{i + 1} = {[ δ {\overline{φ}}_{i + 1}^{1} … δ {\overline{φ}}_{i + 1}^{M} ]}^{T}$$

for the step (i+1) and saved in delay block 226 using the equation:

$$δ {\overline{φ}}_{i + 1} = δ {\overline{φ}}_{i} + {α}^{ind} {Z}_{i}^{cor} , \qquad ( 14 )$$

where transfer coefficient α^{ind} 228 is set equal to the value 0.05.

In one embodiment, NS measurements are rejected when the vector of IL discriminator signals

$${Z}_{i}^{d , ind}$$

is formed. In one embodiment, IA estimates (equation 12) and residual predictions (equation 14) are generated, if there is loss of tracking NS signals.

After coordinate estimates and receiver time scale \hat{X}ᵢ 218 defined using the equation \hat{X}ᵢ=[\hat{x}ᵢ, ŷᵢ, \hat{z}ᵢ, \hat{q}ᵢ]^{T} are formed based on the set of signals of the IL discriminators, smoothed coordinate estimates X̌ᵢ 230 defined using the equation X̌ᵢ=[x̌ᵢ, y̌ᵢ, žᵢ, q̌ᵢ]^{T}, velocity V̌ᵢ 232 defined using the equation V̌ᵢ=[v̌_{x,i}, v̌_{y,i}, v̌_{z,i}, v̌_{q,i}] and accelerations Ǎᵢ 234 defined using the equation Ǎᵢ=[ǎ_{x,i}, ǎ_{y,i}, ǎ_{z,i}, ǎ_{q,i}] are calculated in smoothing filter block 250 using a smoothing filter. As applied to an abstract coordinate t (i.e., one of the x, y, z, q coordinates), smoothed estimates are formed in accordance with the expression:

$${\breve{t}}_{i} = {\overline{t}}_{i} + {K}_{1} δ {t}_{i} , {\check{ν}}_{t , i} = {\overline{v}}_{t . i} + {K}_{2} \frac{{δ}_{i}}{{T}_{e}} , {\breve{a}}_{t , i} = {\overline{a}}_{t , i} + {K}_{3} \frac{δ {t}_{i}}{{T}_{e}^{2}} , \qquad ( 15 )$$

where δtᵢ=\hat{t}ᵢ−t̅ᵢ is the difference between the current LSM coordinate estimate \hat{t}ᵢ and prediction t̅ᵢ, coefficients K₁, K₂ and K₃ for SF are set differently for geometric coordinates x, y, z

$${K}_{1} = 0 \text{.95} , {K}_{2} = 1.1 , {K}_{3} = 0.8 . \qquad ( 16 )$$

For a smoothing filter of receiver time scale q, coefficients K₁, K₂ and K₃ are calculated as follows:

$${K}_{1} = \frac{2 ( 2 z - 1 )}{z ( z + 1 )} , {K}_{2} = \frac{6}{z ( z + 1 )} , {K}_{3} = 0 , and \\ \\ \\ z = 15.$$

Predictions of coordinates X̅ᵢ 208 defined by the equation X̅ᵢ=[\hat{x}ᵢ, ŷᵢ, \hat{z}ᵢ, \hat{q}ᵢ]^{T}, velocities V̅ᵢ 236 defined by the equation V̅ᵢ=[v̅_{x,i}, v̅_{y,i}, v̅_{z,i}, v̅_{q,i}], and accelerations Āᵢ 238 defined by the equation Āᵢ=[ā_{x,i}, ā_{y,i}, ā_{z,i}, ā_{q,i}] are calculated based on smoothed estimates of SF (shown in equation 15). In particular, for an abstract coordinate t (i.e., one of coordinates x, y, z, q)

$${\overline{t}}_{i} = {\breve{t}}_{i - 1} + {\breve{v}}_{t , i - 1} {T}_{e} + {\breve{a}}_{t , i - 1} \frac{{T}_{e}^{2}}{2} {T}_{e} , {\overline{v}}_{t , i} = {\check{v}}_{t , i - 1} + {\breve{a}}_{t , i - 1} {T}_{e} , {\overline{a}}_{t , i} = {\breve{a}}_{t , i - 1} . \qquad ( 17 )$$

Thus, predictions are computed at step i−1 in prolongation block 252 and stored in the delay blocks 254, 256, 258 shown in FIG. 2 for use at step i.

The initialization and restart of buffer corrector 106 are as follows.

Initialization is performed when BC 106 is turned on for the first time, and restart is performed if the PVT solution is lost.

At the time of initialization or restart of BC 106, the following conditions must be met: there is a relatively accurate PVT solution (RTK, PPP etc.; and the RMS estimate of the coordinate estimation errors is less than 0.04 m); signals are being received from at least a certain number of NS (for example, 6 or more); and the estimated accuracy of the available PVT solution is higher than the specified one (i.e., the RMS estimate of the coordinate estimation errors is less than 0.04 m).

If these conditions are met, initialization or restart is performed using the following steps: BC coordinates \hat{X}₀=[\hat{x}₀, ŷ₀, \hat{z}₀]^{T} and X̌₀=[x̌₀, y̌₀, ž₀]^{T} are set to the current coordinate estimates of the navigation solution X₀=[x₀, y₀, z₀]^{T}; the receiver's time scale estimate \hat{q}₀ is set to receiver time scale (“RTS”) q₀; velocities V̌₀=[v̌_{x,0}, v̌_{y,0}, v̌_{z,0}, v̌_{q,0}] are set to current estimates of the PVT solution V₀=[v_{x,0}, v_{y,0}, v_{z,0}, v_{q,0}]; and estimates of integer correction are set to zero:

$${\hat{N}}_{corr , 0}^{j} = 0.$$

Initial residuals are calculated according to the difference of the measured and calculated FP using the equation:

$$δ {\hat{φ}}_{0}^{j} = {φ}_{0}^{j} - {\hat{φ}}_{calc , 0}^{j} , \qquad ( 18 )$$

where

$${φ}_{0}^{j}$$

is measure FP at the time of BC initialization or restart

$${\hat{φ}}_{calc , 0}^{j}$$

is calculated FP at the same time.

In one embodiment, BC correction is performed every 2 seconds as follows.

At the time of BC correction, the same conditions should be met as at initialization and restart, namely: there is a relatively accurate navigation solution (RTK, PPP etc.); signals are being received from at least a certain number of NS (for example, 6 or more); and the estimated accuracy of the available PVT solution is higher than the specified one (i.e., the RMS estimate of the coordinate estimation errors is less than 0.04 m).

If the conditions are satisfied, the correction is performed as follows: BC coordinates \hat{X}ᵢ=[\hat{x}ᵢ, ŷᵢ, \hat{z}ᵢ]^{T} and X̌ᵢ=[x̌ᵢ, y̌ᵢ, žᵢ]^{T} are set equal to the current estimates of PVT solution Xᵢ=[xᵢ, yᵢ, zᵢ]^{T}; and integer correction estimates set to zero

$${\hat{N}}_{corr , i}^{j} = 0.$$

In one embodiment, tracking a new NS is performed as follows. At the start of tracking a new j-th NS estimates of integer correction

$${\hat{N}}_{corr , i}^{j}$$

are set to zero, and residuals are calculated according to (equation 18).

In one embodiment, a rejection flag is formed for an external application in response to anomalous measurements. For two-side weak integration, it is necessary to introduce a mechanism for rejecting NS measurements for external applications (an additional mechanism in relation to the rejection already considered). In one embodiment, an algorithm with the conditional name “peak detector” (also referred to as Peak.D) is used.

In one embodiment, Peak.D is needed due to the fact that in the BC, the FP rejection flag is set for only one epoch, since an integer correction is performed. For anomalies associated with single FP jumps/slips, this approach is acceptable. However, with reflected signal tracking (RST), the FP reject flag will be periodic: when an integer correction occurs, the anomaly is not detected and the reject flag is reset, while the reject flag is generated between integer correction moments.

The algorithm below is for rejecting anomalous FP measurements (in one embodiment, the entire RST) for external applications Peak.D. In one embodiment, test signal Peak.

$$D {\hat{ε}}_{i - 1}^{j}$$

for the j-th NS generated at the previous epoch serves for calculation of its estimate for the current epoch using the equation:

$${\overline{ε}}_{i}^{j} = f {\hat{ε}}_{i - 1}^{j} ,$$

where f=exp {−αTₑ} is determined by the duration of epoch Tₑ and coefficient α.

In one embodiment, current estimate

$${\hat{ε}}_{i}^{j}$$

is calculated according to discriminator signals

$${z}_{i}^{d , ind , j}$$

in accordance with the following rule:

$${\hat{ε}}_{i}^{j} = \{ \begin{matrix}{\overline{ε}}_{i}^{j} , & {\overline{ε}}_{i}^{j} > \vert {z}_{i}^{d , ind , j} \vert , \\ \vert {z}_{i}^{d , ind , j} \vert , & {\overline{ε}}_{i}^{j} \leq \vert {z}_{i}^{d , ind , j} \vert ,\end{matrix} . \qquad ( 20 )$$

If the signals (equation 20) exceed the external rejection threshold h_{φ}, then the FP external rejection flag is set.

To reduce the rejection delay time for very large FP slips, the maximum signal value

$${\hat{ε}}_{i}^{j}$$

is limited by εₘₐₓ=1 . . . 2 m. In addition, at the time of adding a new

$$NS {\overline{ε}}_{0}^{j} = 0.$$

In various embodiments, Peak.D algorithms can be implemented for different frequency ranges.

It should be noted that multiple adders 248, 260, 262, 264, 266, 268, and 270 are used to sum inputs to each adder.

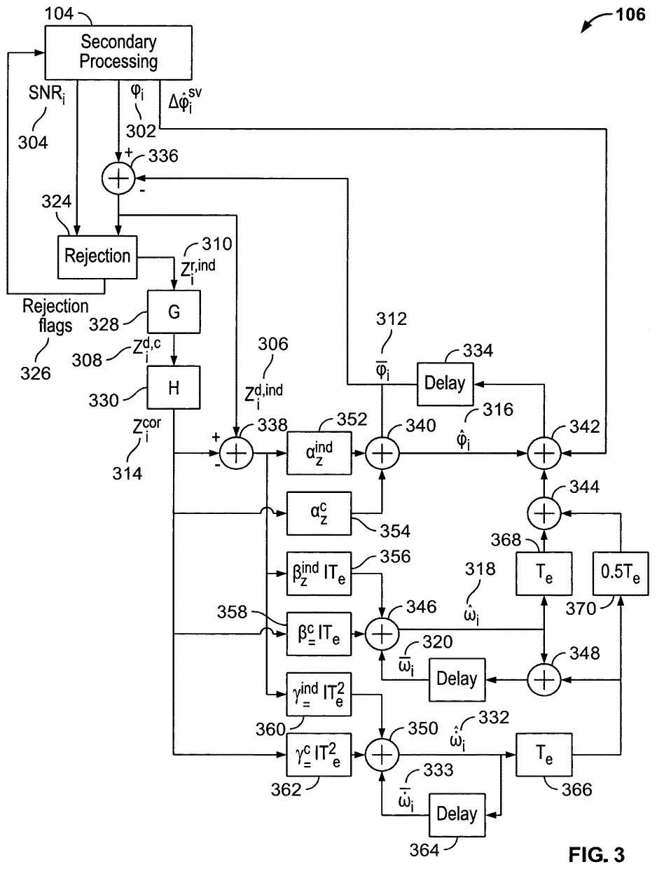

FIG. 3 shows a block diagram of a second embodiment in which BC block 106 is implemented with a secondary co-op and a FP prolongation of a navigation solution. In this embodiment, BC-min with two-side weak integration based on secondary Co-Op with integer FP correction is described.

The difference between the embodiment shown in FIG. 3 and the embodiment shown in FIG. 2 is that in the embodiment shown in FIG. 2, the PVT solution and FP residuals are prolonged, and in the embodiment shown in FIG. 3, the FP is prolonged.

At the i-th step of the algorithm for M observed NS we have: observed FP φᵢ 302 defined using the equation

$${φ}_{i} = {[ {φ}_{i}^{1} … {φ}_{i}^{j} … {φ}_{i}^{M} ]}^{T}$$

at the output of secondary processing block 104; FP predictions φ̅ᵢ 312 defined using the equation

$${\overline{φ}}_{i} = {[ {\overline{φ}}_{i}^{1} … {\overline{φ}}_{i}^{j} … {\overline{φ}}_{i}^{M} ]}^{T}$$

at the output of delay block 334; and signal-to-noise ratio SNRᵢ 304 defined using the equation

$${SNR}_{i} = [ {SNR}_{i}^{1} … {SNR}_{i}^{j} … {SNR}_{i}^{M} ]$$

at the output of secondary processing block 104.

For each tracked NS, the differences between the observed and predicted FPs are calculated, i.e., IL discriminator signals, using the equation:

$${z}_{i}^{d , ind , j} = {φ}_{i}^{j} - {\overline{φ}}_{i}^{j} . \qquad ( 21 )$$

A vector of IL discriminator signals

$${Z}_{i}^{d , ind}$$

306 defined using the equation:

$${Z}_{i}^{d , i𝔫d} ≡ {[ {z}_{i}^{d , ind , 1} … {z}_{i}^{d , ind , M} ]}^{T} .$$

The obtained values

$${z}_{i}^{d , ind , j}$$

in rejection block 324 are verified according to two criteria:

$${SNR}_{i}^{j}$$

for the j-th NS being greater than hₛₙᵣ (for example, 10 dB·Hz); and value

$${Z}_{i}^{d , ind , j}$$

by modulo being smaller than threshold h_{φ} (for example, 0.08 m).

If for signal

$${z}_{i}^{d , ind , j}$$

one of the criteria is not met, the corresponding signal is rejected. Rejection flag 326 is generated by rejection block 324 and output to secondary processing block 104.

Using N non-rejected signals

$${z}_{i}^{d , ind , j}$$

a vector of IL discriminator signals

$${Z}_{i}^{r , ind} ≡ {[ {z}_{i}^{d , ind , 1} … {z}_{i}^{d , ind , N} ]}^{T}$$

is generated and CL discriminator signals are calculated using the equation:

$${Z}_{i}^{d , c} = {G}_{i} \cdot {Z}_{i}^{r , ind} ≡ {[ {z}_{i}^{d , x} ; {z}_{i}^{d , y} ; {z}_{i}^{d , z} ; {z}_{i}^{d , q} ]}^{T} , \qquad ( 22 )$$

where

$${Z}_{i}^{d , c}$$

308,

$${Z}_{í}^{r , ind}$$

310, and Gᵢ 328 are shown in FIG. 2 and

$${G}_{i} = {[ {H}_{i}^{T} {W}_{i} {H}_{i} ]}^{- 1} {H}_{i}^{T} {W}_{i} , {H}_{i}$$

is the directional cosine matrix added by a unit column, and Wᵢ is the diagonal weight matrix, whose elements are proportional to

$${SNR}_{i}^{j} .$$

Diagonal elements are calculated using the equation shown in equation 6.

Next, the 4-dimensional vector

$${Z}_{i}^{d , c}$$

is projected onto the satellite line of sight. As a result, a M-directional vector of correction signals

$${Z}_{i}^{cor}$$

is generated using the equation:

$${Z}_{i}^{cor} = H \cdot {Z}_{i}^{d , c} ≡ [ {z}_{i}^{cor , 1} … {z}_{i}^{cor , j} … {z}_{i}^{cor , M} ] , \qquad ( 23 )$$

where

$${Z}_{i}^{cor}$$

### 314, H 330, and

$${Z}_{i}^{d , c}$$

308 are shown in FIG. 2. Estimate equation (in general case, 3^{rd} order equation comprising \hat{φ}ᵢ 316, \hat{ω}ᵢ 318, and \hat{\dot{ω}}ᵢ 332) is as follows:

$$\begin{matrix}{\overline{φ}}_{i} = {\overline{φ}}_{i} + {α}_{k}^{ind} ( {Z}_{i}^{d , ind} - {Z}_{i}^{cor} ) + {α}_{k}^{c} \cdot {Z}_{i}^{cor} \\ {\hat{ω}}_{i} = {\overline{ω}}_{i} + \frac{1}{{T}_{e}} {β}_{k}^{ind} ( {Z}_{i}^{d , ind} - {Z}_{i}^{cor} ) + \frac{1}{{T}_{e}} {β}_{k}^{c} \cdot {Z}_{i}^{cor} \\ {\hat{\dot{ω}}}_{i} = {\overline{\dot{ω}}}_{i} + \frac{1}{{T}_{e}^{2}} {γ}_{k}^{ind} ( {Z}_{i}^{d , ind} - {Z}_{i}^{cor} ) + \frac{1}{{T}_{e}^{2}} {γ}_{k}^{c} \cdot {Z}_{i}^{cor}\end{matrix} \} . \qquad ( 24 )$$

Here coefficients of CL

$${α}_{k}^{c} , {β}_{k}^{c} , {γ}_{k}^{c}$$

and coefficients of IL

$${α}_{k}^{ind} , {β}_{l}^{ind} , {γ}_{k}^{ind}$$

are calculated according to equations:

$$\begin{matrix}{α}_{k} = ( 9 {k}^{2} - 9 k + 6 ) / Δ \\ {β}_{k} = ( 36 k - 18 ) / Δ \\ {y}_{k} = 60 / Δ \\ Δ = k ( {k}^{2} + 3 k + 2 )\end{matrix} \} . \qquad ( 25 )$$

In one embodiment, in equations 25, CL coefficients k=3, and for IL coefficients k=27.

Prediction equations (generally for 3rd order) for step i:

$$\begin{matrix}{\overline{φ}}_{i} = {\hat{φ}}_{i - 1} + {\hat{ω}}_{i - 1} \cdot {T}_{e} + \frac{1}{2} {\hat{\dot{ω}}}_{i - 1} \cdot {T}_{e}^{2} + Δ {\hat{φ}}_{i - 1}^{SV} \\ {\overline{ω}}_{i} = {\hat{ω}}_{i - 1} + {\hat{\dot{ω}}}_{i - 1} \cdot {T}_{e} \\ {\overline{\dot{ω}}}_{i} = {\overline{\dot{ω}}}_{i - 1}\end{matrix} \} , \qquad ( 26 )$$

where φ̅ᵢ 312, ω̅ᵢ 320, and \overline{\dot{ω}}ᵢ 333 are shown in FIG. 3 and Tₑ is the duration of an epoch (for example, Tₑ=0.1 s or 0.01 s), and

$$Δ {\hat{φ}}_{i - 1}^{SV} = [ Δ {\hat{φ}}_{i - 1}^{SV , 1} … Δ {\hat{φ}}_{i - 1}^{SV , j} … Δ {\hat{φ}}_{i - 1}^{SV , M} ]$$

is the FP correction to movement of the j-th NS calculated according to ephemeris information. Predictions are computed at step i−1 and stored in the delay block 334 for use at step i.

In one embodiment, initialization of BC 106 of FIG. 3 occurs as follows. When BC starts, the calculated FP

$${φ}_{calc , 0}^{j}$$

based on the current receiver coordinates X₀=[x₀, y₀, z₀]^{T} is used as a prediction for FP

$${\overline{φ}}_{0}^{j}$$

used to calculate IL discriminator signal for j-th NS.

In one embodiment, this is performed by calculating coordinates of j-th NS at the time of signal emission (coordinates

$${x}_{0}^{j} , {y}_{0}^{j} , {z}_{0}^{j} )$$

and NS time scale drift

$${q}_{sv , 0}^{j}$$

for the current epoch using ephemeris information; and calculating a priori pseudoranges based on the calculated NS coordinates and a priori estimates of receiver's geometrical coordinates (x₀, y₀, z₀) using the equation:

$${D}_{o}^{j} = \sqrt{{( {x}_{0} - {x}_{o}^{j} )}^{2} + {( {y}_{0} - {y}_{0}^{j} )}^{2} + {( {z}_{0} - {z}_{o}^{j} )}^{2}} . \qquad ( 27 )$$

Calculated FP is computed including corrections to account for Earth rotation

$${D}_{rot , 0}^{j} ,$$

troposphere delays,

$${D}_{trot , 0}^{j} ,$$

and ionosphere delays

$${D}_{ion , 0}^{j} ,$$

receiver time scale drift q₀, and NS time scale drift

$${q}_{sv , 0}^{j}$$

using the equation:

$${φ}_{calc , 0}^{j} = {D}_{0}^{j} + {D}_{rot , 0}^{j} + {D}_{trop , 0}^{j} - {D}_{ion , 0}^{j} + {q}_{0} - {q}_{sv , 0}^{j} . \qquad ( 28 )$$

Subsequently, IL discriminator signal

$${z}_{0}^{d , ind , j}$$

can be calculated for NS j using the equation:

$${z}_{0}^{d , ind , j} = {φ}_{0}^{j} - {φ}_{calc , 0}^{j} . \qquad ( 29 )$$

After initialization, BC 106 operates as described above in connection with FIG. 3.

In one embodiment, when a new NS signal provided to BC 106, an IL discriminator signal for the new NS signal is calculated according to equation 29.

The buffer correctors, operating as described above, were considered when working with single-frequency measurements. In one embodiment a method for generating IL discriminator signals for multi-frequency receivers is as follows.

NS in modern navigation systems emit radio signals in several frequency ranges at once. Therefore, it is relevant to use their joint processing to calculate the CL discriminator signals

$${Z}_{i}^{d , c} = {[ {z}_{i}^{d , x} , {z}_{i}^{d , y} , {z}_{i}^{d , z} , {z}_{í}^{d , q} ]}^{T} .$$

In one embodiment, joint processing is used, for example, with an NS which emits signals in K frequency bands.

In this embodiment, at the i-th step for a j-th NS there are K measured FP

$$[ {φ}_{i}^{1 , j} … {φ}_{i}^{K , j} ]$$

and K FP predictions

$$[ {\overline{φ}}_{i}^{1 , j} … {\overline{φ}}_{i}^{K , j} ]$$

(or FP residual estimates

$$[ δ {\overline{φ}}_{i}^{1 , j} … δ {\overline{φ}}_{i}^{K , j} ] ) .$$

An IL discriminator signal is determined for each frequency band f using one of the equations:

$${z}_{i}^{d , ind , f , j} = {φ}_{i}^{f , j} - {\overline{φ}}_{i}^{f , j} or \qquad ( 30 )$$

$${z}_{i}^{d , ind , f , j} = {δφ}_{i}^{f , j} - δ {\overline{φ}}_{i}^{f , j} . \qquad ( 30 \text{*)}$$

The obtained values

$${z}_{i}^{d , ind , f , j}$$

are verified according to two criteria: SNR for j-th NS in frequency band f being greater than threshold hₛₙᵣ; and absolute value of

$${z}_{i}^{d , ind , f , j}$$

being smaller than threshold h_{φ}.

If, for signal

$${z}_{i}^{d , ind , f , j} ,$$

one of the criteria is not satisfied, the corresponding signal is rejected. A corresponding rejection flag 326 is generated by rejection block 324 and transmitted to secondary processing block 104 shown in FIG. 3.

A complex IL discriminator signal

$${z}_{i}^{d , ind , j}$$

is formed from L non-rejected signals of the A complex IL discriminator signal j-th NS using the equation:

$${z}_{i}^{d , ind , j} = \frac{1}{L} {\sum }_{f = 1}^{L} {z}_{i}^{d , ind , f , j} . \qquad ( 31 )$$

The complex signal of the IL discriminator (equation 31) is used in the BC to calculate the signals of the CL discriminators. Further operations in the BC do not change compared to the single-frequency case.

It should be noted that multiple adders 336, 338, 340, 342, 344, 346, 348, and 350 are used to sum inputs to each adder.

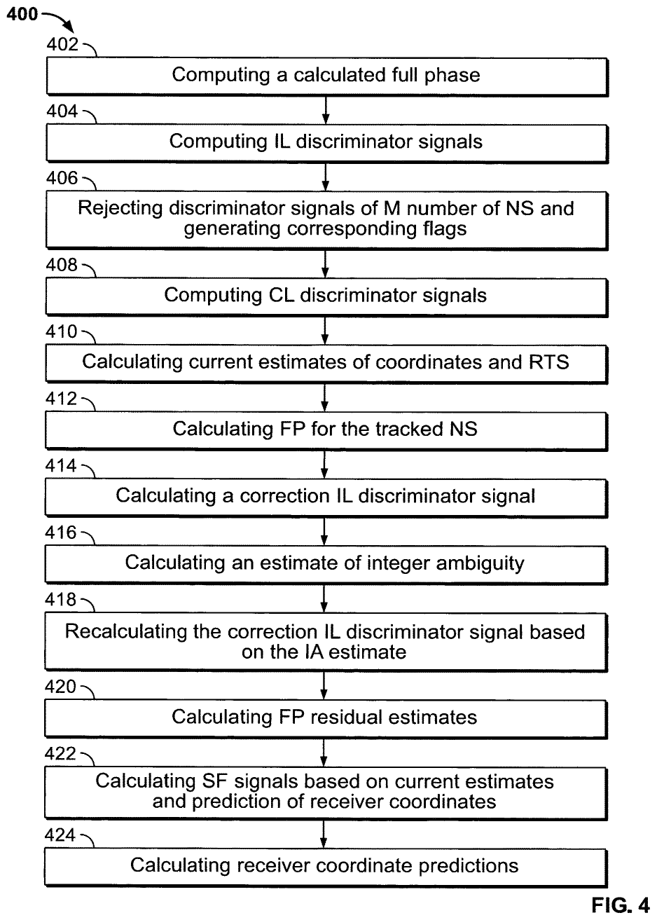

FIG. 4 shows a flowchart of a method 400 for rejecting anomalous measurements and prolonging a navigation solution of a GNSS receiver according to one embodiment. At step 402, a calculated full phase (“FP”) for tracked navigation satellites (“NS”) is computed based on the GNSS receiver's coordinate predictions. At step 404, IL discriminator signals for the tracked NS are computed. At step 406, discriminator signals of M number of NS are rejected and corresponding flags are generated. At step 408, CL discriminator signals are computed based on K number of non-rejected IL discriminator signals. At step 410, current estimates of coordinates and the GNSS receiver's time scale (“RTS”) are calculated. At step 412 FP for the tracked NS are calculated based on current estimates of the GNSS receiver coordinates. At step 414, a correction IL discriminator signal for the M number of NS is calculated. At step 416, an estimate of integer ambiguity (“IA”) is calculated. At step 418, the correction IL discriminator signal based on the IA estimate is recalculated. At step 420, FP residual estimates are calculated. At step 422, SF signals based on current estimates and prediction of receiver coordinates are calculated. At step 424, receiver coordinate predictions are calculated.

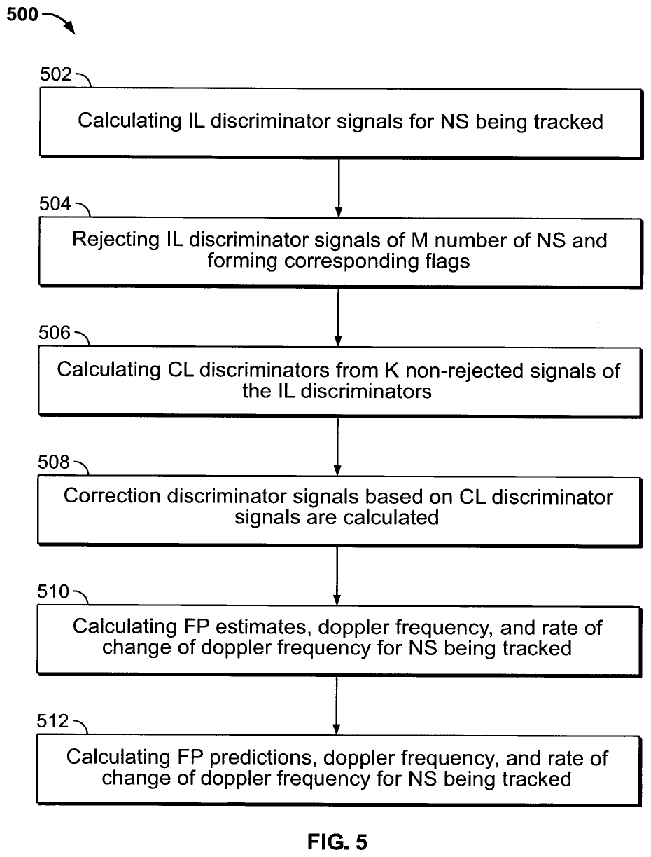

FIG. 5 shows a flowchart of a method 500 for rejecting anomalous measurements and . . . prolongation of FP according to one embodiment. At step 502, IL discriminator signals for NS being tracked are calculated. At step 504, IL discriminator signals of M number of NS are rejected and corresponding flags are formed. At step 506, CL discriminators from K non-rejected signals of the IL discriminators are calculated. At step 508, correction discriminator signals based on CL discriminator signals are calculated. At step 510, FP estimates, Doppler frequency, and rate of change of Doppler frequency for NS being tracked are calculated. At step 512, FP predictions, Doppler frequency, and rate of change of Doppler frequency for the NS being tracked are calculated.

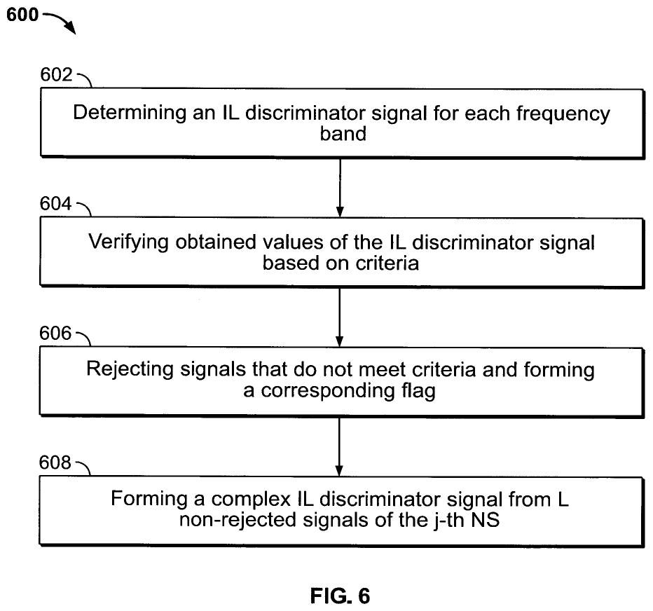

FIG. 6 shows a flowchart of a method 600 for generating of IL discriminator signals in multi-frequency receivers for NS emitting signals in K frequency band according to one embodiment. At step 602, an IL discriminator signal

$${z}_{i}^{d , ind , f , j}$$

for each frequency band f is determined. At step 604, obtained values

$${z}_{i}^{d , ind , f , j}$$

are verified based on criteria comprising SNR for j-th NS in frequency band f being greater than threshold hₛₙᵣ, and the absolute value of

$${z}_{i}^{d , ind , f , j}$$

being smaller than threshold h_{φ}. At step 606, if for signal

$${z}_{i}^{d , ind , f , j}$$

one of the criteria is not satisfied, the corresponding signal is rejected and a corresponding flag is formed. At step 608, complex IL discriminator signal

$${z}_{i}^{d , ind , j}$$

is formed from L non-rejected signals of the j-th NS using equation:

$${z}_{i}^{d , ind , j} = \frac{1}{L} {\sum }_{f = 1}^{L} {z}_{i}^{d , ind , f , j} .$$

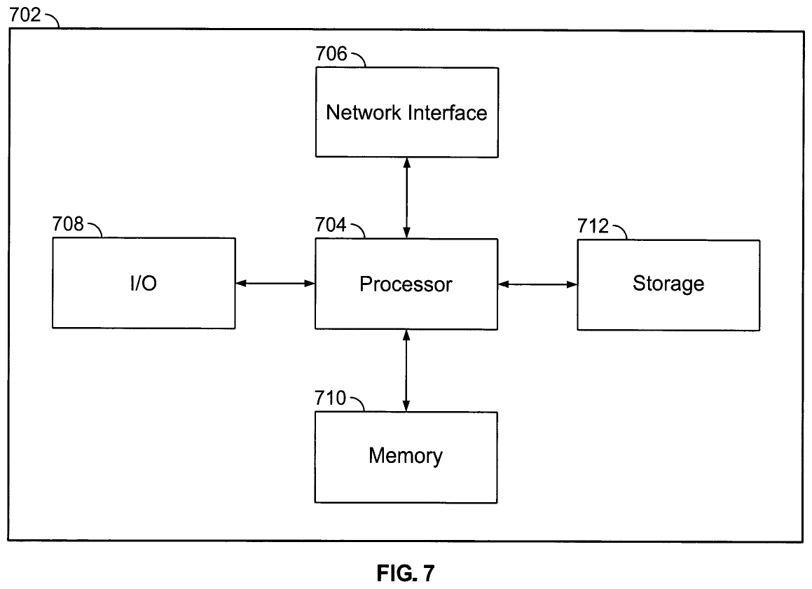

Any of the components, operations, or methods shown in FIGS. 1-6 can be implemented using a computer. A high-level block diagram of such a computer is illustrated in FIG. 7. Computer 702 contains a processor 704 which controls the overall operation of the computer 702 by executing computer program instructions which define such operation. The computer program instructions may be stored in a storage device 712, or other computer readable medium (e.g., magnetic disk, CD ROM, etc.), and loaded into memory 710 when execution of the computer program instructions is desired. Thus, the operations of FIGS. 2 and 3 and method steps of FIGS. 4, 5, and 6 can be defined by the computer program instructions stored in the memory 710 and/or storage 712 and controlled by the processor 704 executing the computer program instructions. For example, the computer program instructions can be implemented as computer executable code programmed by one skilled in the art to perform an algorithm defined by the operations of FIGS. 2 and 3 and method steps of FIGS. 4, 5, and 6. Accordingly, by executing the computer program instructions, the processor 704 executes an algorithm defined by the operations of FIGS. 2 and 3 and method steps of FIGS. 4, 5, and 6. The computer 702 also includes one or more network interfaces 406 for communicating with other devices via a network. The computer 702 also includes input/output devices 708 that enable user interaction with the computer 702 (e.g., display, keyboard, mouse, speakers, buttons, etc.) One skilled in the art will recognize that an implementation of an actual computer could contain other components as well, and that FIG. 7 is a high-level representation of some of the components of such a computer for illustrative purposes.

The foregoing Detailed Description is to be understood as being in every respect illustrative and exemplary, but not restrictive, and the scope of the inventive concept disclosed herein is not to be determined from the Detailed Description, but rather from the claims as interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

1. A method for rejecting anomalous measurements and prolonging a navigation solution of a global navigation satellite system (“GNSS”) receiver, the method comprising:
computing a calculated full phase (“FP”) for tracked navigation satellites (“NS”) based on the GNSS receiver's coordinate predictions;
computing IL discriminator signals for the tracked NS;
rejecting discriminator signals of M number of NS and generating corresponding flags;
computing CL discriminator signals based on K number of non-rejected IL discriminator signals;
calculating current estimates of coordinates and the GNSS receiver's time scale (“RTS”);
calculating FP for the tracked NS based on current estimates of the GNSS receiver coordinates;
calculating a correction IL discriminator signal for the M number of NS;
calculating an estimate of integer ambiguity (“IA”);
recalculating the correction IL discriminator signal based on the IA estimate;
calculating FP residual estimates;
calculating SF signals based on current estimates and prediction of receiver coordinates; and
calculating receiver coordinate predictions.

2. The method of claim 1 wherein the calculated FP is computed based on a prediction of receiver coordinates for the M number of NS, and a calculated FP for a j-th NS based on receiver coordinate prediction X̅ᵢ=[\hat{x}ᵢ, ŷᵢ, \hat{z}ᵢ]^{T} is calculated as a calculated pseudorange
$${\overline{D}}_{i}^{j}$$
based on corrections to Earth rotation
$${D}_{rot , 0}^{j} ,$$
troposphere delays
$${D}_{trop , 0}^{j}$$
and ionosphere delays
$${D}_{ion , 0}^{j} ,$$
receiver time scale drift q̅ᵢ, and NS time scale drift
$${q}_{sv , i}^{j}$$
$${\overline{φ}}_{calc , i}^{j} = {\overline{D}}_{i}^{j} + {D}_{rot , i}^{j} + {D}_{trop , i}^{j} - {D}_{ion , i}^{j} + {\overline{q}}_{i} - {q}_{sv , i}^{j} where$$
$${\overline{D}}_{i}^{j} = \sqrt{{( {\overline{x}}_{i} - {x}_{i}^{j} )}^{2} + {( {\overline{y}}_{i} - {y}_{i}^{j} )}^{2} + {( {\overline{z}}_{i} - {z}_{i}^{j} )}^{2}} , and$$
$${x}_{sv , i}^{j} , {y}_{sv , i}^{j} , {z}_{sv , i}^{j}$$
are coordinates of the j-th NS at the time of signal emission.

3. The method of claim 1 wherein
IL discriminator signal
$${z}_{i}^{d , ind , j}$$
for the j-th NS is calculated as a difference of residual
$${δφ}_{i}^{j}$$
and a prediction of this residual
$$δ {\overline{φ}}_{i}^{j} :$$
$${z}_{i}^{d , ind , j} = {δφ}_{i}^{j} - δ {\overline{φ}}_{i}^{j} ,$$
where residual
$${δφ}_{i}^{j}$$
is calculated as a difference of a measured FP
$${φ}_{i}^{j}$$
and a calculated FP
$${\overline{φ}}_{calc , i}^{j}$$
based on a prediction of IA
$${\overline{N}}_{corr , i}^{j}$$
$${δφ}_{i} = {φ}_{i} - {\overline{φ}}_{calc , i} - λ {\overline{N}}_{corr , i}$$
where
$${φ}_{i} = {[ {φ}_{i}^{1} … {φ}_{i}^{j} … {φ}_{i}^{M} ]}^{T}$$
the measured FP of NS,
$${\overline{φ}}_{calc , i} = {[ {\overline{φ}}_{calc , i}^{1} … {\overline{φ}}_{calc , i}^{M} ]}^{T} ,$$
$${\overline{N}}_{corr , i} = {[ {\overline{N}}_{corr , i}^{1} … {\overline{N}}_{corr , i}^{M} ]}^{T} ,$$
and λ is the wavelength of NS signal.

4. The method of claim 1 wherein a signal of the IL discriminator
$${z}_{i}^{d , ind , j}$$
of the jth NS is rejected and the corresponding flag is generated if
$${SNR}_{i}^{j}$$
is less than threshold hₛᵤᵣ or value
$${z}_{i}^{d , ind , j}$$
in absolute value is less than threshold h_{φ}, wherein there are N non-rejected signals of IL discriminators.

5. The method of claim 1 wherein CL discriminator signal
$${Z}_{i}^{d , c} = {[ {z}_{i}^{d , x} , {z}_{i}^{d , y} , {z}_{i}^{d , y} , {z}_{i}^{d , q} ]}^{T}$$
are calculated by a least squares method (“LSM”) according to N non-rejected IL discriminator signal
$${Z}_{i}^{d , ind} = {[ {z}_{i}^{d , ind , 1} , {z}_{i}^{d , ind , 2} , … , {z}_{i}^{d , ind , N} ]}^{T}$$
$${Z}_{i}^{d , c} = {G}_{i} {Z}_{i}^{d , ind} ≡ {[ {z}_{i}^{d , x} ; {z}_{i}^{d , y} ; {z}_{i}^{d , z} ; {z}_{i}^{d , q} ]}^{T} ,$$
where
$${G}_{i} = {[ {H}_{i}^{T} {W}_{i} {H}_{i} ]}^{- 1} {H}_{i}^{T} {W}_{i} , {H}_{i}$$
is a directional cosine matrix added by a unit column for N non-rejected NS and added by 4 rows with unit elements arranged diagonally, Wᵢ is the diagonal weight matrix, whose elements are proportional to
$${SNR}_{i}^{j}$$
for N non-rejected NS, and diagonal elements are calculated using equation
$${w}_{i}^{j} = {10}^{0.1 {SNR}_{i}^{f}} .$$

6. The method of claim 1 wherein current estimates of the receiver and RTS coordinates \hat{X}ᵢ=[\hat{x}ᵢ, ŷᵢ, \hat{z}ᵢ, \hat{q}ᵢ] are calculated using the current prediction of the receiver coordinates, RTS X̅ᵢ, and CL discriminators
$${Z}_{i}^{d , c}$$
according to equation:
$${\hat{X}}_{i} = {\overline{X}}_{i} + {Z}_{i}^{d , c} .$$

7. The method of claim 1 wherein the calculated FP for j-th NS based on receiver coordinates \hat{X}ᵢ=[\hat{x}ᵢ, ŷᵢ, \hat{z}ᵢ]^{T} is calculated as a calculated pseudorange
$${\hat{D}}_{i}^{j}$$
including corrections to Earth rotation
$${D}_{rot , 0}^{j} ,$$
troposphere delays
$${D}_{trot , 0}^{j} ,$$
and ionosphere delays
$${D}_{ion , 0}^{j} ,$$
receiver time scale drift \hat{q}ᵢ, and NS time scale drift
$${q}_{sv , i}^{j}$$
using equation:
$${\hat{φ}}_{calc , i}^{j} = {\hat{D}}_{i}^{j} + {D}_{rot , i}^{j} + {D}_{trot , i}^{j} - {D}_{ion , i}^{j} + {\hat{q}}_{i} - {q}_{sv , i}^{j} where$$
$${\hat{D}}_{i}^{j} = \sqrt{{( {\hat{x}}_{i} - {x}_{i}^{j} )}^{2} + {( {\hat{y}}_{i} - {y}_{i}^{j} )}^{2} + {( {\hat{z}}_{i} - {z}_{i}^{j} )}^{2}} , and$$
$${x}_{sv , i}^{j} , {y}_{sv , i}^{j} , {z}_{sv , i}^{j}$$
are coordinates of the j-th NS at the time of signal emission.

8. The method of claim 1 wherein IL discriminator correction signals
$${Z}_{i}^{cor}$$
for M NS are calculated as a difference of residuals
$${δφ}_{i}^{cor}$$
and a prediction of these residuals δφ̅ᵢ using equation:
$${Z}_{i}^{cor} = {[ {z}_{i}^{cor , 1} … {z}_{i}^{cor , M} ]}^{T} = {δφ}_{i}^{cor} - δ {\overline{φ}}_{i}$$
where residual
$${δφ}_{i}^{cor , j}$$
for the j-th NS is calculated as a difference of the measured FP
$${φ}_{i}^{j}$$
and calculated FP
$${\hat{φ}}_{calc , i}^{j}$$
using equation:
$${δφ}_{i}^{cor , j} = {φ}_{i}^{j} - {\hat{φ}}_{calc , i}^{j} .$$

9. The method of claim 1 wherein IA estimate for the j-th NS is corrected based on the IL discriminator correction signal defined by equation:
$${\hat{N}}_{corr , i}^{j} = {\overline{N}}_{corr , i}^{j} + {δ N}_{i}^{j}$$
where
$$δ {N}_{i}^{j} = floor \{ \frac{{z}_{i}^{cor , j}}{λ} \}$$
—is the correction to IA, and floor{ } is the operation of rounding up to the previous integer.

10. The method of claim 1 wherein IL discriminator correction signals for the M number of NS are re-calculated using the correction to IA determined using equation:
$${Z}_{i}^{cor} ← {Z}_{i}^{cor} - λ δ {N}_{i}$$
where
$$δ {N}_{i} = {[ δ {N}_{i}^{1} … δ {N}_{i}^{M} ]}^{T}$$
are corrections to IA for M NS, and ← is the operation of replacement of the original values by new ones.

11. The method of claim 1 wherein FP residual estimates
$$δ {\overline{φ}}_{i + 1} = {[ {\overline{φ}}_{i + 1}^{1} … δ {\overline{φ}}_{i + 1}^{M} ]}^{T}$$
at the (i+1)-th step are calculated based on a residual prediction for the i-th step and corrected signals of IL discriminators using equation:
$$δ {\overline{φ}}_{i + 1} = δ {\overline{φ}}_{i} = {α}^{ind} {Z}_{i}^{cor}$$
where α^{ind}=0.05.

12. The method of claim 1 wherein smoothed estimates X̌ᵢ=[x̌ᵢ, y̌ᵢ, žᵢ, q̌ᵢ]^{T}, V̌ᵢ=[v̌_{x,i}, v̌_{y,i}, v̌_{z,i}, v̌_{q,i}] and Ǎᵢ=[ǎ_{x,i}, ǎ_{y,i}, ǎ_{z,i}, ǎ_{q,i}] are calculated with smoothing filters (“SF”) using equations:
$${\breve{t}}_{i} = {\overline{t}}_{i} + {K}_{1} δ {t}_{i} ,$$
$${\breve{v}}_{t , i} = {\overline{v}}_{t , i} + {K}_{2} \frac{δ {t}_{i}}{{T}_{e}} ,$$
$${\breve{a}}_{t , i} = {\overline{a}}_{t , i} + {K}_{3} \frac{δ {t}_{i}}{{T}_{e}^{2}} ,$$
where t is the abstract coordinate taking values (x, y, z, q), δtᵢ=\hat{t}ᵢ−t̅ᵢ is the difference of the current coordinate estimate \hat{t}ᵢ and prediction t̅ᵢ, coefficients K₁, K₂ and K₃ for coordinate SF (i.e., for x, y, z) are set to
$${K}_{1} = 0.85 ,$$
$${K}_{2} = 1.1 , and$$
$${K}_{3} = 0.8$$
where RTS q coefficients K₁, K₂ and K₃ of the smoothing filters are calculated as
$${K}_{1} = \frac{2 ( 2 z - 1 )}{z ( z + 1 )} ,$$
$${K}_{2} = \frac{6}{z ( z + 1 )} ,$$
$${K}_{3} = 0 , and$$
$$z = 15 ,$$

13. The method of claim 1 wherein predictions X̅ᵢ=[x̅ᵢ, y̅ᵢ, z̅ᵢ, q̅ᵢ]^{T}, V̅ᵢ=[v̅_{x,i}, v̅_{y,i}, v̅_{z,i}, v̅_{q,i}] and Āᵢ=[ā_{x,i}, ā_{y,i}, ā_{z,i}, ā_{q,i}] are calculated based on smoothed estimates X̌ᵢ=[x̌ᵢ, y̌ᵢ, žᵢ, q̌ᵢ]^{T}, V̌ᵢ=[v̌_{x,i}, v̌_{y,i}, v̌_{z,i}, v̌_{q,i}] and Ǎᵢ=[ǎ_{x,i}, ǎ_{y,i}, ǎ_{z,i}, ǎ_{q,i}], wherein, abstract coordinate t (x, y, z, q) is calculated using equations:
$${\overline{t}}_{i} = {\breve{t}}_{i - 1} + {\breve{v}}_{t , i - 1} {T}_{e} + {\breve{a}}_{t , i - 1} \frac{{T}_{e}^{2}}{2} {T}_{e} ,$$
$${\overline{v}}_{t , i} = {\breve{v}}_{t , i - 1} + {\breve{a}}_{t , i - 1} {T}_{e} , and$$
$${\overline{a}}_{t , i} = {\breve{a}}_{t , i - 1} .$$

14. The method of claim 4 wherein a method for generating a rejection flag for anomalous measurements Peak.D comprises the steps:
at the i-th step based on IL discriminator signal
$${z}_{i}^{d , ind , j}$$
and an estimate of the test signal
$${\overline{ε}}_{i}^{j} ,$$
for the j-th NS an estimate of the test signal
$${\hat{ε}}_{i}^{j}$$
is calculated
$${\hat{ε}}_{i}^{j} = \{ \begin{matrix}{\overline{ε}}_{i}^{j} , {\overline{ε}}_{i}^{j} > \vert {z}_{i}^{d , ind , j} \vert , \\ \vert {z}_{i}^{d , ind , j} \vert , {\overline{ε}}_{i}^{j} \leq \vert {z}_{i}^{d , ind , j} \vert\end{matrix} ;$$
the estimate of the test signal
$${\hat{ε}}_{i}^{j}$$
is compared with threshold h_{φ}, and if
$${\hat{ε}}_{i}^{j} > {h}_{φ} ,$$
a rejection flag is formed, otherwise, this rejection flag is removed; and
a prediction of the test signal for the j-th NS for the (i+1)-th step is generated
$${\overline{ε}}_{i + 1}^{j} = f {\hat{ε}}_{i}^{j} ,$$
where f=exp {−αTₑ} is determined by epoch duration Tₑ and LFF bandwidth α.

15. The method of claim 1 wherein initialization and restart comprises the steps:
BC coordinates \hat{X}₀=[\hat{x}₀, ŷ₀, \hat{z}₀]^{T} and X̌₀=[x̌₀, y̌₀, ž₀]^{T} are set to the current coordinate estimates of the navigation solution Xᵢ=[x₀, y₀, z₀]^{T};
RTS estimate \hat{q}₀ is set equal to RTS qᵢ from the navigation solution;
velocity estimates V̌₀=[v̌_{x,0}, v̌_{y,0}, v̌_{z,0}, v̌_{q,0}] are set equal to the current estimates of navigation velocity solution V₀=[v_{x,0}, v_{y,0}, v_{z,0}, v_{q,0}];
integer correction estimates are set
$${\hat{N}}_{corr , 0}^{j} = 0 ;$$
and
initial FP residuals for the j-th NS are computed according to the difference of measured and calculated FP
$$δ {\hat{φ}}_{0}^{j} = {φ}_{0}^{j} - {\hat{φ}}_{calc , 0}^{j} ,$$
where
$${φ}_{0}^{j}$$
is measured FP at the time of BC initialization or restart,
$${\hat{φ}}_{calc , 0}^{j}$$
is the calculated FP at the same time according to \hat{X}₀.

16. The method of claim 1 wherein a correction method is performed every 2 seconds, the correction method comprising:
setting coordinates \hat{X}ᵢ=[\hat{x}ᵢ, ŷᵢ, \hat{z}ᵢ]^{T} and X̌ᵢ=[x̌ᵢ, y̌ᵢ, žᵢ]^{T} equal to the current estimates of the navigation solution Xᵢ=[xᵢ, yᵢ, zᵢ]^{T};
setting velocities V̌ᵢ=[v̌_{x,i}, v̌_{y,i}, v̌_{z,i}] equal to the current estimates of velocity solution Vᵢ=[v_{x,i}, v_{y,i}, v_{z,i}]; and
estimates of integer correction are
$${\hat{N}}_{corr , i}^{j} = 0.$$

17. The method of claim 1 further comprising:
adding a new j-th NS, the adding the new j-th NS comprises:
estimating integer correction
$${\hat{N}}_{corr , i}^{j} = 0 ;$$
and
calculating initial FP residual for the j-th NS based on the difference of measured FP and calculated FP
$$δ {\hat{φ}}_{0}^{j} = {φ}_{0}^{j} - {\hat{φ}}_{calc , 0}^{j} .$$

18. An apparatus comprising an antenna configured to receive signals from a GNSS satellite and transmit those signals to a buffer corrector via an RF part, ADC, primary processing block, and secondary processing block, the buffer corrector configured to perform the method of claim 1.

19. A method for rejecting anomalous measurements and prolongation of FP comprising:
calculating IL discriminator signals for NS being tracked;
rejecting IL discriminator signals of M number of NS and forming corresponding flags;
calculating CL discriminators from K non-rejected signals of the IL discriminators;
calculating correction discriminator signals based on CL discriminator signals;
calculating FP estimates, Doppler frequency and rate of change of Doppler frequency for NS being tracked; and
calculating FP predictions, Doppler frequency and rate of change of Doppler frequency for the NS being tracked.

20. The method of claim 19 wherein the step of computing IL discriminator signals for the NS being tracked comprises:
calculating the IL discriminator signal
$${z}_{i}^{d , ind , j}$$
for the j-th NS as a difference of the measured FP
$${φ}_{i}^{j}$$
and FP estimate FP
$${\overline{φ}}_{i}^{j}$$
using equation:
$${z}_{i}^{d , ind , j} = {φ}_{i}^{j} - {\overline{φ}}_{i}^{j} .$$

21. The method of claim 19 wherein the step of rejecting IL discriminator signals of M number of NS and forming corresponding flags comprises:
rejecting IL discriminator signal
$${z}_{i}^{d , ind , j}$$
of the j-th NS and forming a corresponding flag if
$${SNR}_{i}^{j}$$
is smaller than threshold hₛₙᵣ or absolute value of
$${z}_{i}^{d , ind , j}$$
is smaller than threshold h_{φ} where a number N of non-rejected IL discriminator signals remain.

22. The method of claim 19 wherein CL discriminator signals
$${Z}_{i}^{d , c} = {[ {z}_{i}^{d , x} , {z}_{i}^{d , y} , {z}_{i}^{d , y} , {z}_{i}^{d , q} ]}^{T}$$
are calculated by an LSM according to N non-rejected IL discriminator signals where
$${Z}_{i}^{d , ind} = {[ {z}_{i}^{d , ind , 1} , {z}_{i}^{d , ind , 2} , … , {z}_{i}^{d , ind , N} ]}^{T} ,$$
and Hᵢ is a directional cosine matrix added by a unit column, Wᵢ is a diagonal weight matrix, whose elements are proportional to
$${SNR}_{i}^{j}$$
for N non-rejected NS wherein diagonal elements are calculated using equation
$${w}_{i}^{j} = {10}^{0.1 {SNR}_{l}^{j}} .$$

23. The method of claim 19 wherein IL discriminator correction signals are calculated based on a vector of CL discriminator signals
$${Z}_{i}^{d , c}$$
being projected to a line-of-sight of a particular one of the NS and, an N-directional vector of correction signals is generated using equation:
$${Z}_{i}^{cor} = H \cdot {Z}_{i}^{d , c} ≡ [ {z}_{i}^{cor , 1} … {z}_{i}^{cor , j} … {z}_{i}^{cor , M} ] .$$

24. The method of claim 19 wherein estimates \hat{φ}ᵢ, \hat{ω}ᵢ and \hat{\dot{ω}}ᵢ for M NS are calculated using FP predictions φ̅ᵢ, Doppler frequency ω̅ᵢ, rate of change of Doppler frequency \overline{\dot{ω}}ᵢ and IL discriminator correction signals
$${Z}_{i}^{cor}$$
using equations:
$$\begin{matrix}{\hat{φ}}_{i} = {\overline{φ}}_{i} + {α}_{k}^{ind} ( {Z}_{i}^{d , ind} - {Z}_{i}^{cor} ) + {α}_{k}^{c} \cdot {Z}_{i}^{cor} \\ {\hat{ω}}_{i} = {\overline{ω}}_{i} + \frac{1}{{T}_{e}} {β}_{k}^{ind} ( {Z}_{i}^{d , ind} - {Z}_{i}^{cor} ) + \frac{1}{{T}_{e}} {β}_{k}^{c} \cdot {Z}_{i}^{cor} \\ {\hat{\dot{ω}}}_{i} = {\overline{\dot{ω}}}_{i} + \frac{1}{{T}_{e}^{2}} {γ}_{k}^{ind} ( {Z}_{i}^{d , ind} - {Z}_{i}^{cor} ) + \frac{1}{{T}_{e}^{2}} {γ}_{k}^{c} \cdot {Z}_{i}^{cor}\end{matrix} \}$$
where CL coefficients
$${α}_{k}^{c} , {β}_{k}^{c} , {γ}_{k}^{c}$$
and IL coefficients
$${α}_{k}^{ind} , {β}_{k}^{ind} , {γ}_{k}^{ind}$$
are calculated using equations:
$$\begin{matrix}{α}_{k} = ( 9 {k}^{2} - 9 k + 6 ) / Δ \\ {β}_{k} = ( 36 k - 18 ) / Δ \\ {γ}_{k} = 60 / Δ \\ Δ = k ( {k}^{2} + 3 k + 2 )\end{matrix} \}$$
where k=3 for CL coefficients, and k=27 for IL coefficients.

25. The method of claim 19 wherein estimates φ̅ᵢ₊₁, ω̅ᵢ₊₁ and \hat{\dot{ω}}ᵢ₊₁ are calculated using equations:
$$\begin{matrix}{\overline{φ}}_{i + 1} = {\hat{φ}}_{i} + {\hat{ω}}_{i} \cdot {T}_{e} + \frac{1}{2} {\hat{\dot{ω}}}_{i} \cdot {T}_{e}^{2} + Δ {\hat{φ}}_{i}^{SV} \\ {\overline{ω}}_{i + 1} = {\hat{ω}}_{i} + {\hat{\dot{ω}}}_{i} \cdot {T}_{e} \\ {\overline{\dot{ω}}}_{i + 1} = {\hat{\dot{ω}}}_{i}\end{matrix} \}$$
where Tₑ is the epoch duration, and
$$Δ {\hat{φ}}_{i}^{SV} = [ Δ {\hat{φ}}_{i}^{SV , 1} … Δ {\hat{φ}}_{i}^{SV , j} … Δ {\hat{φ}}_{i}^{SV , M} ]$$
FP correction to movement of the j-th NS is calculated based on ephemeris information.

26. The method of claim 19, wherein adding a new j-th NS comprises:
calculating coordinates of the j-th NS using ephemeris information at the moment of signal emission (coordinates
$${x}_{i}^{j} , {y}_{i}^{j} , {z}_{i}^{j}$$
and NS time scale drift
$${q}_{sv , i}^{j}$$
for a current epoch;
calculating a priori pseudo-ranges using computed NS coordinates and a priori estimates of receiver coordinates (xᵢ, yᵢ, zᵢ) using equation:
$${D}_{i}^{j} = \sqrt{{( {x}_{i} - {x}_{i}^{j} )}^{2} + {( {y}_{i} - {y}_{i}^{j} )}^{2} + {( {z}_{i} - {z}_{i}^{j} )}^{2}} ;$$
computing calculated FP based on Earth rotation
$${D}_{rot , i}^{j} ,$$
troposphere delays
$${D}_{trop , i}^{j}$$
and ionosphere delay
$${D}_{ion , i}^{j} ,$$
RTS drift qᵢ and NS time scale drift
$${q}_{sv , i}^{j}$$
using equation:
$${φ}_{calc , i}^{j} = {D}_{i}^{j} + {D}_{rot , i}^{j} + {D}_{trop , i}^{j} - {D}_{ion , i}^{j} + {q}_{i} - {q}_{sv , i}^{j} ;$$
and
where IL discriminator signal is calculated
$${z}_{i}^{d , ind , j}$$
for the j-th NS using equation:
$${z}_{i}^{d , ind , j} = {φ}_{i}^{j} - {φ}_{calc , i}^{j} .$$

27. An apparatus comprising an antenna configured to receive signals from a GNSS satellite and transmit those signals to a buffer corrector via an RF part, ADC, primary processing block, and secondary processing block, the buffer corrector configured to perform the method of claim 19.

28. A method for generating IL discriminator signals in multi-frequency receivers for NS emitting signals in K frequency band, the method comprising:
determining an IL discriminator signal
$${z}_{i}^{d , ind , f , j}$$
for each frequency band f;
verifying obtained values
$${z}_{i}^{d , ind , f , j}$$
based on criteria comprising SNR for j-th NS in frequency band f being greater than threshold hₛₙᵣ, and the absolute value of
$${z}_{i}^{d , ind , f , j}$$
being smaller than threshold h_{φ} where,
if for signal
$${z}_{i}^{d , ind , f , j}$$
one of the criteria is not satisfied, the corresponding signal is rejected and a corresponding flag is formed; and
forming complex IL discriminator signal
$${z}_{i}^{d , ind , j}$$
from L non-rejected signals of the j-th NS using equation:
$${z}_{i}^{d , ind , j} = \frac{1}{L} {\sum }_{f = 1}^{L} {z}_{i}^{d , ind , f , j} .$$

29. An apparatus comprising an antenna configured to receive signals from a GNSS satellite and transmit those signals to a buffer corrector via an RF part, ADC, primary processing block, and secondary processing block, the buffer corrector configured to perform the method of claim 28.
